(19) United States
(12) Patent Application Publication
(10) Pub. No.: US 2015/0309195 A1
(43) Pub. Date: Oct. 29, 2015

(54) SYSTEM AND METHOD FOR USING VEHICLE MOTION AS A LAND SEISMIC SOURCE

(71) Applicant: CGG SERVICES SA, Massy Cedex (FR)

(72) Inventor: John J. SALLAS, Plano, TX (US)

(21) Appl. No.: 14/690,514

(22) Filed: Apr. 20, 2015

Related U.S. Application Data
(60) Provisional application No. 61/983,489, filed on Apr. 24, 2014.

(51) Int. Cl. G01V 1/00; G01L 1/00; G01P 15/08; G01V 1/18; G01V 1/24

(52) U.S. Cl. CPC G01V 1/005; G01V 1/18; G01V 1/24; G01P 15/08; G01L 1/00

(57) ABSTRACT

Method and source assembly for enhancing low-frequency seismic signals. The source assembly includes a vehicle configured to move to a desired location above ground; a lift and hydraulic actuator system attached to the vehicle and configured to generate seismic waves into the ground; auxiliary equipment attached to the vehicle; and one or more sensors located on the vehicle or the auxiliary equipment for measuring a vertical acceleration or a representation of the vertical acceleration of the source assembly.

### CROSS-REFERENCE TO RELATED APPLICATIONS

This application claims priority and benefit from U.S. Provisional Patent Application No. 61/983,489, filed on Apr. 24, 2014, entitled “Method for Using Vehicle Motion as a Land Seismic Source”, the disclosure of which is incorporated here by reference.

### BACKGROUND

1. Technical Field

Embodiments of the subject matter disclosed herein generally relate to methods and systems and, more particularly, to mechanisms and techniques for harnessing low-frequency energy generated by a carrier of a land seismic source.

2. Discussion of the Background

Seismic data acquisition and processing generate a profile (image) of subterranean geophysical structures. While this profile does not provide an accurate location of oil and gas reservoirs, it suggests, to those trained in the field, the presence or absence of these reservoirs. Thus, providing a high-resolution image of the geophysical structures is an ongoing process.

To obtain a high-resolution image of the underground, a seismic survey system employs a seismic source that generates seismic waves, and seismic receivers that record seismic signals associated with the seismic waves. The seismic source imparts energy to the ground. The energy travels through the subsurface and gets reflected from certain subsurface geological formations, e.g., boundaries or layers. The reflected energy travels back to the surface, where the seismic receivers record it. The recorded data is processed to yield information about the location and physical properties of the layers making up the subsurface.

For land explorations, the seismic source may be a vibratory source. The energy transmitted by the vibratory source to the ground is proportional with force acting on it. For land seismic surveys, it is desirable to transmit as much energy as possible to the ground. Thus, the heavier the truck, the more weight is available to keep the baseplate in contact with the earth enabling larger actuators to be used to drive the baseplate to transmit more vibratory energy into the earth.

Large hydraulic vibrators mounted on vehicle carriers equipped with tires or tracks are commonly used for geophysical exploration. Typically, a vehicle carrier 100, as illustrated in FIG. 1, moves to a pre-determined shot point 102. The carrier 100 uses a lift system 116 to lower a baseplate 118 that couples vibratory energy into the earth 120. A static hold-down force is also applied to the baseplate to preload it, using a portion of the vehicle weight so that during a sweep, the baseplate remains in good contact with the earth. The vibrator 122 then generates a sweep that typically lasts for 8 to 16 s, but in some cases may be shorter or last up to 60 s, to produce a seismic signal 124 useful for illuminating subterranean features 126.

After the sweep is completed, the baseplate is raised, the vehicle moves up to the next shot point and the process repeats. During a typical day of seismic acquisition, the vibrator spends more time raising and lowering the baseplate and moving to a new position than sweeping.

Large land vibrators in common use today are capable of full energy output over the range of about 7-90 Hz. Outside this band, the maximum deliverable vibratory force (ground force) is limited due to constraints imposed by limiting factors in the mechanical and/or hydraulic system.

There is increasing interest in extending seismic survey bandwidth to lower frequencies, i.e., below 10 Hz, to facilitate later imaging processing steps like acoustic inversion. In the recent past, low-dwell sweeps have been developed to boost the low-frequency output of seismic vibrators with some success; however, because of stroke limitations, peak low-frequency amplitude levels are quite weak and the dwell times must become very long. The challenge of delivering sufficient low-frequency energy while still producing enough energy at moderate and high frequency for imaging can prove quite difficult when the cost of a survey is also considered.

Thus, there is a need for developing a seismic source that generates increased low-frequency energy at a low cost.

### SUMMARY

According to an embodiment, there is a land-based source assembly for enhancing low-frequency seismic signals. The source assembly includes a vehicle configured to move to a desired location above ground; a lift and hydraulic actuator system attached to the vehicle and configured to generate seismic waves into the ground; auxiliary equipment attached to the vehicle; and one or more sensors located on the vehicle or the auxiliary equipment for measuring a vertical acceleration or a representation of the vertical acceleration of the source assembly.

According to another embodiment, there is a method for capturing a low-frequency energy generated by a source assembly. The method includes a step of determining how many parts of the source assembly have a weight above a given threshold; a step of locating on each part that has its weight above the given threshold one or more sensors for measuring a corresponding acceleration; a step of connecting each of the one or more sensors to a controller; and a step of configuring the controller to calculate a force F_{c} applied by the source assembly to the ground through its tires or tracks.

According to still another embodiment, there is a method for enhancing a low-frequency energy generated by a source assembly. The method includes moving the source assembly from one shot point to another shot point; lowering or raising a baseplate of a lift and hydraulic actuator system at a given shot point; recording vertical displacements of the source assembly with one or more sensors while the source assembly moves from the one shot point to another shot point or while the baseplate is lowered or raised; processing the vertical displacements in a controller to determine a vertical force F_{c} applied by the source assembly to the ground; and using the vertical force F_{c} to process seismic data recorded with seismic sensors.

### BRIEF DESCRIPTION OF THE DRAWINGS

The accompanying drawings, which are incorporated in and constitute a part of the specification, illustrate one or more embodiments and, together with the description, explain these embodiments. In the drawings:

FIG. 1 is a schematic diagram of a truck-mounted vibratory source;

FIG. 2 is a schematic diagram of a source assembly having one or more sensors that monitor vertical displacement or acceleration of the assembly;

FIG. 3 illustrates a land-based seismic survey system;

FIG. 4 illustrates a move-up stage of a source assembly;

FIG. 5 illustrates various time intervals corresponding to sweeping and moving from shot point to shot point for a given source assembly;

FIG. 6 is another source assembly having one or more sensors that monitor vertical displacement or acceleration of the assembly;

FIG. 7 is a schematic diagram showing the mass distribution of a source assembly;

FIGS. 8A and 8B illustrate an interaction between the ground and a source assembly while traveling;

FIG. 9 is still another source assembly having one or more sensors that monitor vertical displacement or acceleration of the assembly;

FIG. 10 is a flowchart of a method for processing move-up and sweep data;

FIG. 11 if a flowchart of a method for determining and distributing one or more sensors on a source assembly; and

FIG. 12 illustrates a computing device that can act as a controller or implement one or more of above methods.

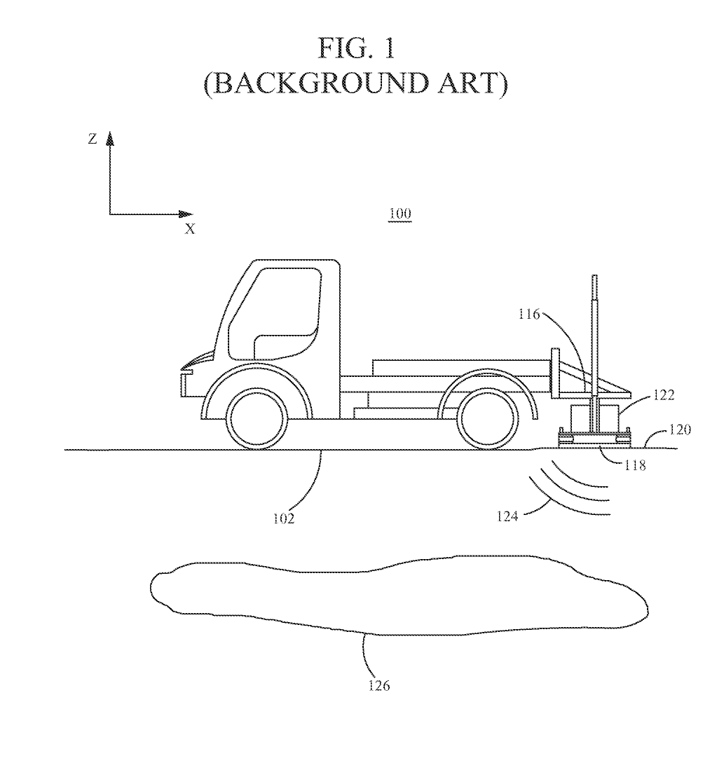

### DETAILED DESCRIPTION

The following description of the exemplary embodiments refers to the accompanying drawings. The same reference numbers in different drawings identify the same or similar elements. The following detailed description does not limit the invention. Instead, the scope of the invention is defined by the appended claims. The following embodiments are discussed, for simplicity, with regard to the terminology and structure of a vibratory source mounted between the axles of a carrier, i.e., a truck or buggy. However, the embodiments to be discussed next are not limited to this system, but may be applied to front-mounted sources and/or back-mounted vibratory sources.

Reference throughout the specification to “one embodiment” or “an embodiment” means that a particular feature, structure or characteristic described in connection with an embodiment is included in at least one embodiment of the subject matter disclosed. Thus, the appearance of the phrases “in one embodiment” or “in an embodiment” in various places throughout the specification is not necessarily referring to the same embodiment. Further, the particular features, structures or characteristics may be combined in any suitable manner in one or more embodiments.

According to an embodiment, there is a land-based source assembly for enhancing low-frequency seismic signals. The source assembly includes a carrier configured to move to a desired location above ground, a lift and hydraulic actuator system attached to the vehicle and configured to generate seismic waves into the ground, auxiliary equipment attached to the vehicle, and one or more sensors located on the vehicle or the auxiliary equipment for measuring a vertical acceleration or a representation of the vertical acceleration of the source assembly. In another embodiment, the land-based source assembly is just a heavy vehicle that supports the seismic survey, for example, a drilling truck, a jug truck, etc. These vehicles are similar to the land-based source assembly to be discussed next except for the presence of a hydraulic vibrator system.

With the trend toward high-productivity acquisition, often times, the seismic receiver (geophones, accelerometers or other known sensors) signals are continuously recorded. The energy generated by the vehicle motion enters the ground and gets reflected by various underground features. The reflected energy is then received by the geophones and becomes part of the signal acquired by the recording system.

Thus, seismic energy created by the motion of heavy equipment when one or more vibrators are not sweeping is recorded. That energy is currently considered noise, and it is being removed during a pre-processing or processing step.

In general, energy resulting from vehicle motion is low-level, but it is concentrated at the low-frequency end of the spectrum. Thus, spectral energy density in this region can be significant, and it can be used to enhance conventional seismic data at this low end of the spectrum. One possible benefit of using the signals generated by the source assembly vertical movement is an improvement in overall signal-to-noise. Moreover, if the seismic energy created by vehicular activity is measured and can be mapped into the signal rather than contaminate the record as noise, this would be an added benefit.

In many seismic reflection surveys, the source assembly spends less than half of its time sweeping in a typical day of data acquisition. The rest of the time is spent moving from one shot point to another shot point and lowering or raising its baseplate. The movement of the vehicle and the movement of the vibrator lift system tend to create low-frequency vibrations that enter the earth through various areas of contact, for example, the vehicle tires or tracks, and the baseplate. By recording a vibration signal representative of this non-sweep activity, a non-sweep motion signal (NSMS) can be computed, and it represents the overall motion of the carrier and actuator (i.e., source assembly). The NSMS for a particular source assembly can then be used as an input to later processing steps and its contribution to the seismic recording computed.

The NSMS in one embodiment could be used as the source signal and in a processing step called signature deconvolution, and the earth impulse response could be computed from the NSMS.

The NSMS may be controlled to be predominantly rich in low-frequency (less than 5 Hz) content. Low-frequency seismic signal wavelengths are quite long compared to the distance between shot points. Thus, even though NSMS energy is distributed spatially over the move-up distance (typically less than 50 m), it can be treated as if it were emitted at a stationary point.

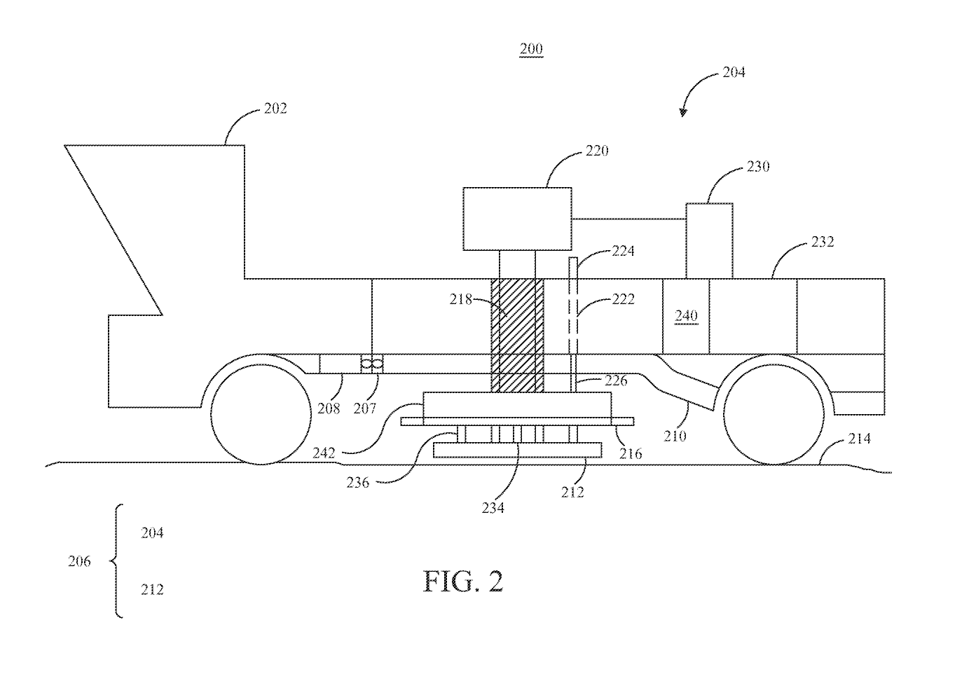

These concepts are now discussed in more detail with reference to the figures. FIG. 2 shows a hydraulic seismic vibrator 200 (e.g., Sercel model Nomad 65). Hydraulic seismic vibrator 200 (simply called “source assembly” herein) includes a carrier 202 (e.g., a truck), a lift and hydraulic actuator system 204 mounted on the carrier, and a baseplate 212. The lift and hydraulic actuator system 204 and baseplate 212 are called herein the “source” 206. The carrier 202 is shown to have an articulated frame, i.e., a rotatable articulation 207 connects the front frame 208 to the back frame 210 of the carrier.

The source assembly may have a rated output of about 276 kN, with a reaction mass of 4,082 kg and a driven structure mass (baseplate assembly) of 1,560 kg. The gross source assembly mass may be about 31,500 kg. These numbers are provided not to limit the applicability of the invention, but rather to give the reader a sense of the masses involved for being able to generate low-frequency energy. The carrier shown in FIG. 2 is a wheeled vehicle, but the invention also applies to carriers equipped with tracks that are even heavier. In this case, the vibrator baseplate 212 is not yet in contact with the ground 214.

The lift and hydraulic actuator system 204 includes a foot piece 216, a pair of guide columns 218 (only one shown in the figure), cross member 220 and hydraulic ram actuator 222. Hydraulic ram actuator 222 includes lift cylinder 224, which is attached to the vehicle frame 210, and lift rod 226. One end of lift rod 226 is attached to foot piece 216, and the other end enters lift cylinder 224. FIG. 2 also shows a hydraulic lift valve 230, which upon receiving a command from a controller 232 operated by the operator, directs flow in and out of the lift cylinders to raise and lower the baseplate. The foot piece 216 is connected non-rigidly to baseplate 212 through a system of airbag isolators 234 and through some chains 236.

After vehicle 202 has moved to its assigned shot point, upon command from controller 232, lift valve 230 directs hydraulic fluid into the lift cylinders 224, and a force is transmitted to foot piece 216 through lift rods 226. Before contacting ground 214, chains 236 are under tension and carry the weight of the baseplate 212 as it is lowered. Guide columns 218 in conjunction with cross member 220 help to synchronize the action of lift cylinders 224 as well as stabilize the vehicle and vibrator assembly, which is important when operating on non-even surfaces.

Once baseplate 212 contacts the ground, the airbags 234 are compressed due to a portion of the vehicle carrier weight being applied as a hold down force through the lift rods 226 to the foot piece 216. The hold down force applied is predetermined by a setting of a pressure regulator valve that controls the pressure applied to the lift cylinder 224. Once the desired hold-down force has been reached, lift valve 230, which is a pressure-regulated valve, and chains 236 are slack, and the vehicle frame 210 is vibration-isolated from the baseplate 212 and the driven structure. During a sweep, the carrier is typically vibration-isolated from the baseplate for frequencies above about 2 Hz.

During a sweep, a servo-valve (not shown) directs high-pressure fluid into internal chambers of the reaction mass 242. The reaction mass bore is configured to act like a double-acting hydraulic cylinder. A sweep is typically a swept frequency sine-wave signal, but other wave shapes are sometimes used. Upon receiving a start command, the vibrator controller 232 creates a drive signal to control the servo-valve. As the servo-valve directs fluid into the reaction mass's upper and lower chambers (not shown), a dynamic force is applied to a hydraulic piston (not shown) that rides inside the reaction mass bore. That piston is rigidly connected to baseplate 212 through piston rod 226 and other structure. Piston rod 226, baseplate 212 and rigidly attached structures are referred to as the driven structure. As the piston accelerates up and down during the sweep, a reaction force is directed to the driven structure. Since baseplate 212 is in direct contact with the ground 214, seismic energy is radiated into the ground.

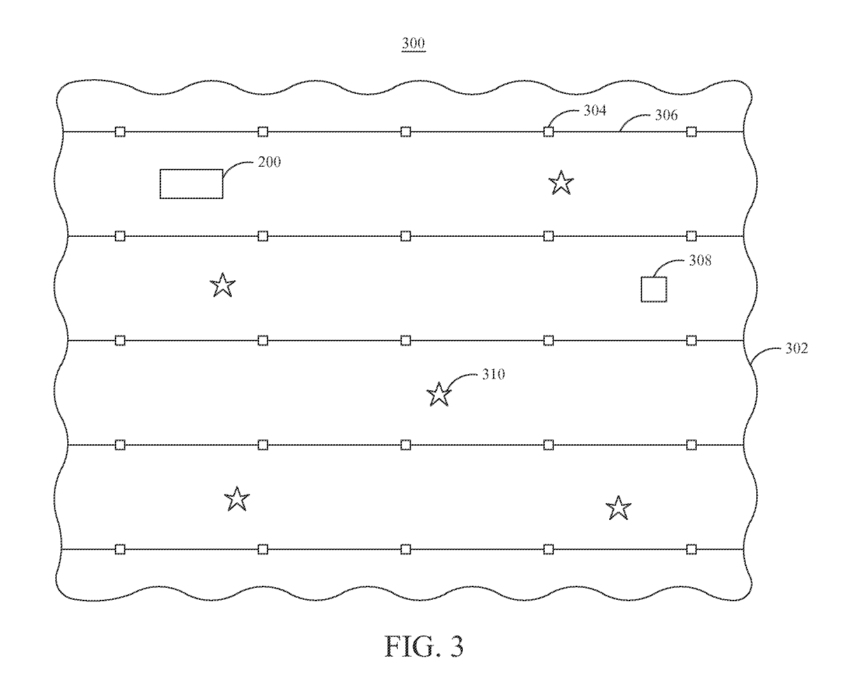

When the sweep is complete, the lift process is reversed and baseplate 212 is raised, and the source assembly is ready to move to another location. FIG. 3 illustrates a surveying system 300 distributed over a surveying area 302. Seismic sensors 304 are distributed over surveying area 302 for recording seismic waves. Sensors 304 may be distributed along lines 306 that form a rectangular grid. However, it is possible to arrange sensors based on other shapes. Sensors can be positioned on or under the ground. Sensors can be connected in a wired, wireless or mixed manner to a central recording station 308. Source 200 moves from one shot location 310 to the next shot location as depicted in FIG. 3. The time required for the source assembly to lift the baseplate, move to the next shot point, and lower the baseplate is called the move-up time.

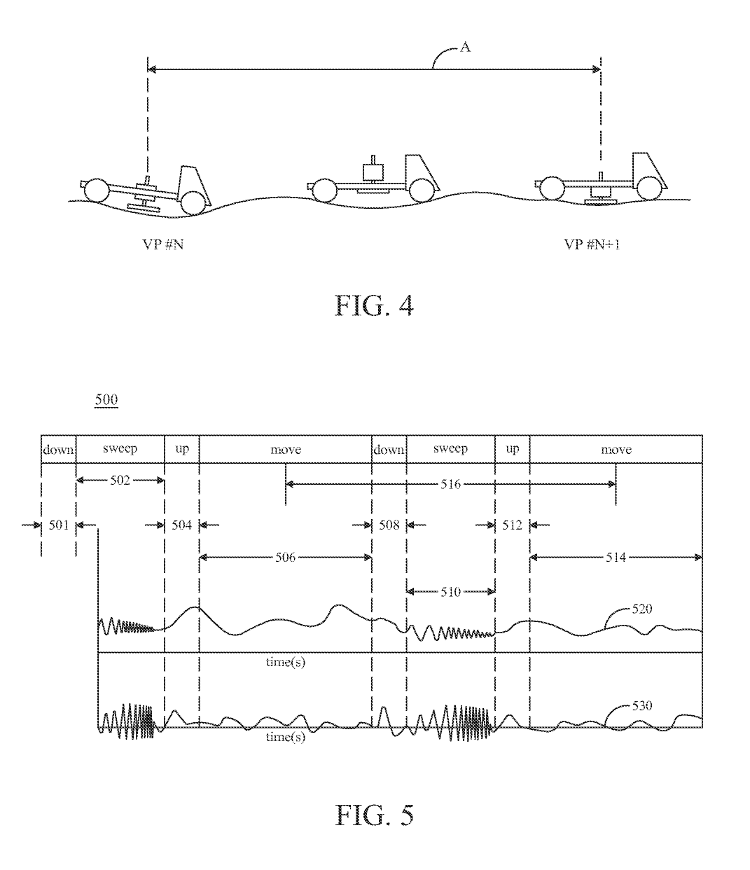

There has been a growing effort to spatially increase sampling and to reduce sweep time at each location. Thus, the time spent moving tends to be greater than the time spent sweeping. FIG. 4 illustrates the move-up process with a source assembly sweeping at vibrating point (VP) #N and then moving a distance A, for example, 20 to 50 m, to the next VP #N+1. Vehicular activity along distance A creates seismic energy that reaches the receivers. If the terrain is rough, even more seismic energy will be produced by this vehicular activity. For buggy-type vehicles, there is little vibration damping as the vehicle moves, and the tires in combination with the vehicle mass can act as a resonant spring-mass system.

FIG. 5 depicts the overall average vertical motion of the source assembly as it sweeps and moves from shot to shot. The term “vertical motion” will be more clearly defined later. Activity chart 500 shows how the assembly source spends its time when seismic data is being acquired. More specifically, the source assembly spends time 501 lowering the baseplate and preparing the lift and hydraulic actuator system to apply a force on the baseplate. Then, during time 502, the source applies a given sweep to impart acoustic energy to the ground. After the source completes sweeping at the end of interval 502, the baseplate is raised during interval 504, and the vibrator travels to the next shot point during time interval 506. After arriving at the new shot point, the source assembly lowers the baseplate during interval 508, sweeps at the new shot point during interval 510, lifts the baseplate again during 512 and moves on during interval 514 to another shot point. This process continues until all the predetermined shot points have been swept.

If the vertical motion generated by the source assembly due to the activity described above is plotted as graph 520, it can be observed that the vertical component of the source assembly's center of mass varies during all of these activities. In this graph it is assumed that the source assembly's center of mass location is relative to a fixed radial distance from the center of the earth (e.g., inertial system), where the fixed radial distance could be the elevation relative to sea level or relative to the average elevation in the geophysical survey area). Because the terrain of the seismic survey may vary in elevation, the vertical component of the source assembly's center of mass changes. The position of the center of mass also changes when the baseplate is lowered during time interval 508 or raised during time interval 512. During time interval 504, corresponding to the sweep, the vertical component of the source assembly's center of mass changes more rapidly due to the up-and-down motion of the reaction mass.

Graph 530 represents the vertical component of the overall source assembly's acceleration during all of this activity. Acceleration 530 is the second derivative in time of the center of mass's vertical displacement 520. Thus, in practice, either one of curves 520 or 530 need to be measured in order to derive/calculate the other one. Going from displacement 520 to acceleration 530 tends to accentuate the amplitude of higher-frequency events, so curve 530 is less smooth than curve 520.

To harness the low-frequency energy generated by the source assembly's movement, it is necessary to estimate as accurately as possible the force exerted by the entire source assembly on the ground. Note that for traditional source assemblies, this force does not need to be known when the source assembly travels between shot points. For a traditional source assembly, only the force exerted on the baseplate needs to be known. However, the force exerted on the baseplate is felt during time interval 510 in FIG. 5, while the force exerted by the entire source assembly on the ground is felt during time intervals 504, 506 and 508, i.e., between sweeping time intervals. In other words, the force exerted on the baseplate is calculated for traditional source assemblies when the baseplate contacts the ground, while the force exerted by the source assembly on the ground is calculated when the baseplate is not in contact with the ground.

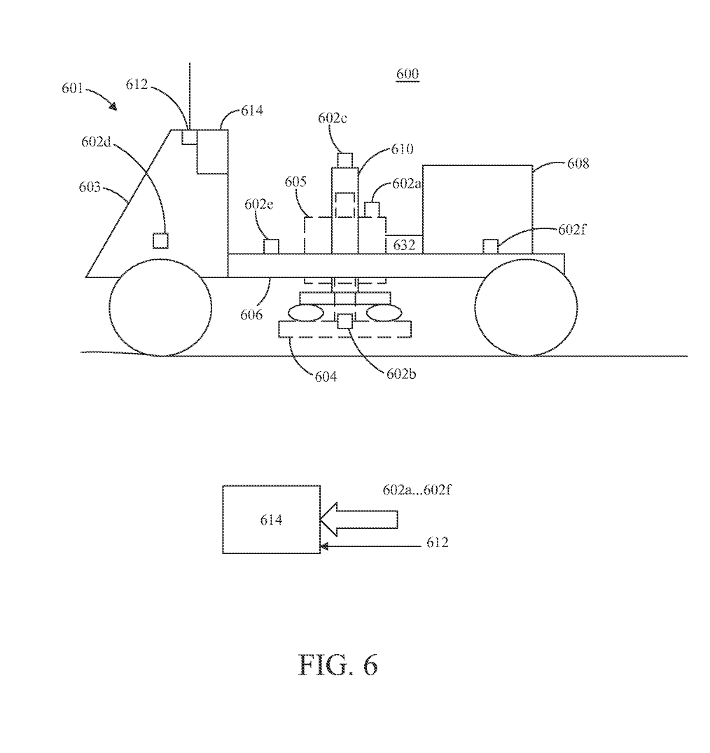

To measure the force exerted by the entire source assembly on the ground, it is necessary to measure the average vertical motion of the source assembly relative to the earth. FIG. 6 illustrates a source assembly 600 equipped with various sensors suitable for measuring the motion of the various components or subassemblies so that the overall average source assembly motion can be estimated. Because the interest is to harvest this information to estimate only the low-frequency content of vehicular activity, high-frequency structural resonance can be ignored.

Source assembly 600 includes a vehicle 601 having a cab 603, a vehicle frame 606, auxiliary equipment 608 (e.g., power pack), a lift and hydraulic actuator system 610, baseplate 604, and a reaction mass 605. FIG. 6 also shows a GPS receiver 612 and a multi-channel source signal acquisition system 614. One or more sensors 602a-f (e.g., accelerometers or equivalent sensors) are each mounted on the aforementioned major components to estimate their average accelerations. In other words, the one or more sensors 602a-f are located on the frame of the vehicle, on the lift and hydraulic actuator system 610, at a few locations and on the auxiliary equipment that has a weight over a given threshold. The auxiliary equipment may also include a compressor 240, a fuel tank, etc. Only those components of the auxiliary equipment that have a weight over the given threshold would have a corresponding sensor for measuring their acceleration. During the field acquisition process, the multi-channel source signal acquisition system 614 receives GPS time and position coordinates and the various measured motion signals from sensors 602a-f. Note that there are two accelerometers in FIG. 6 on vehicle frame 606; accelerometer 602e is forward and accelerometer 602f is at the rear (if the vehicle frame is articulated as illustrated in FIG. 2, it may be helpful to use more than one sensor to provide a reasonable estimate).

Accelerometers 602a-f can be MEMs-type that are responsive to gravity, and they may be 3-component type. For simplicity, it is assumed that single-component vertical accelerometers are used in the embodiment of FIG. 6. One or more of the accelerometers are connected to a controller 632 configured to receive acceleration data while the source assembly is on the move. In order to improve the measured vertical force applied by the source assembly to the ground while the baseplate is not in contact with the ground, the acceleration sensors may be redistributed along the source assembly. This sensor redistribution may happen before or during the survey. Note that sensors 602a-f can directly measure acceleration or a representation of the acceleration (e.g., real-time displacement or velocity). According to this embodiment, it is assumed that the source assembly can be broken down into a finite number of rigid subassemblies, and that each subassembly's motion is measured by a corresponding accelerometer to provide a valid estimate of its low-frequency motion.

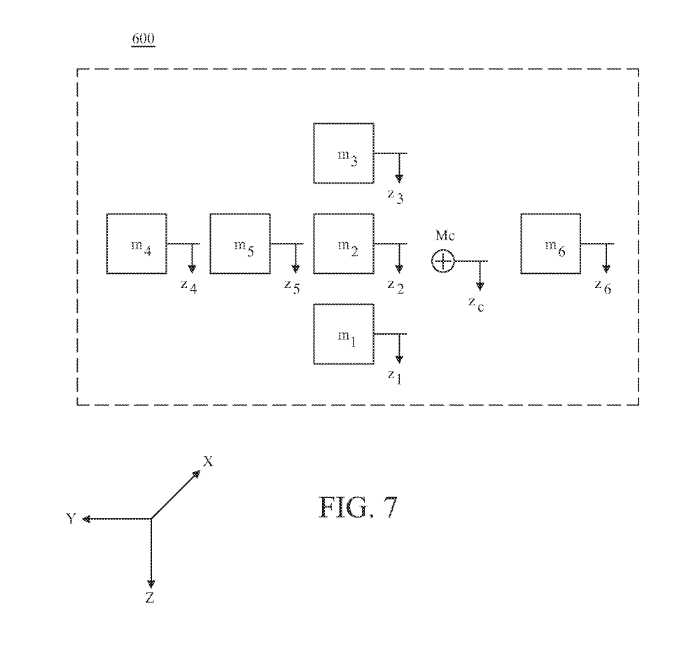

In this regard, FIG. 7 illustrates a mass distribution for the source assembly 600 that links the various subassemblies' motions to an average vehicle motion. Note that in FIG. 7 the direction of positive motion (Z₁ . . . Z₆) for each subassembly mass (m₁ . . . m₆) is assumed to be toward the center of the earth (down is positive, which is different than the polarity conventions used for FIG. 5). This convention was chosen to conform with the Society of Exploration Geophysicists (SEG) positive-polarity convention used for geophone receivers and accelerometers used for forming the weighted sum estimate for ground force in the field. Vectors Z₁ . . . Z₆ represent the displacement relative to an arbitrary point in space (or referential system XYZ illustrated in FIG. 7) that is at a fixed radial distance from the center of the earth. Accelerometers 602a-f measure the corresponding acceleration signals a₁ . . . a₆ due to motions Z₁ . . . Z₆ for each subassembly. Each subassembly has a mass larger than a given threshold. If the mass of a subassembly is smaller than the threshold, then that subassembly will barely affect the vertical force F_{c}. For this reason, that subassembly may be ignored. Corresponding masses that are shown correspond to the effective mass of a particular subassembly. In a particular case, m₁ represents the driven structure (baseplate) mass, m₂ represents the reaction mass, m₃ the lift structure, m₄ the cab, m₅ the forward portion of the frame, and m₆ the rear portion of the frame and power pack. More or fewer masses may be used to describe a source assembly. This breakdown of the source assembly into subassemblies may be decided by the source assembly's operator or by a computer program that has as input the specifications of the source assembly. The number of subassemblies may be decided by the operator based on experience or by the computer program that is programmed to select only those components of the source assembly which are heavier than a given threshold. Once the subassemblies have been selected/identified, a corresponding sensor is attached to each of them to monitor a vertical motion of these subassemblies during the source move-up.

Special consideration may be paid to certain subassemblies that have flexible members, for example, the front tires. Because the front tires are not rigidly attached to the frame, only a portion of their mass would be included in m4. Thus, an overall estimate of the product between (1) the source assembly's vertical acceleration (a_{c}) and (2) the overall source assembly's mass (M_{c}), could be computed by utilizing the acceleration measurements in combination with their respective subassembly masses, where a_{c} corresponds to the second derivative with respect to time of the vertical displacement Z_{c} of the source assembly's center of mass. In other words:

M_{c}(a_{c})=m₁(a₁)+m₂(a₂)+ . . . +m₆(a₆). (1)

Equation (1) is similar to the way the weighted sum ground force estimate is formed. Optimal placement of the accelerometers and the effective mass of each subassembly could be computed using Finite Element Method (FEM) in combination with source assembly manufacture information, and it may be validated by empirical means.

The total vertical compressive contact force Fc applied to the earth, either through the tires/tracks or baseplate, is given by:

F_{c}=−M_{c}(a_{c}). (2)

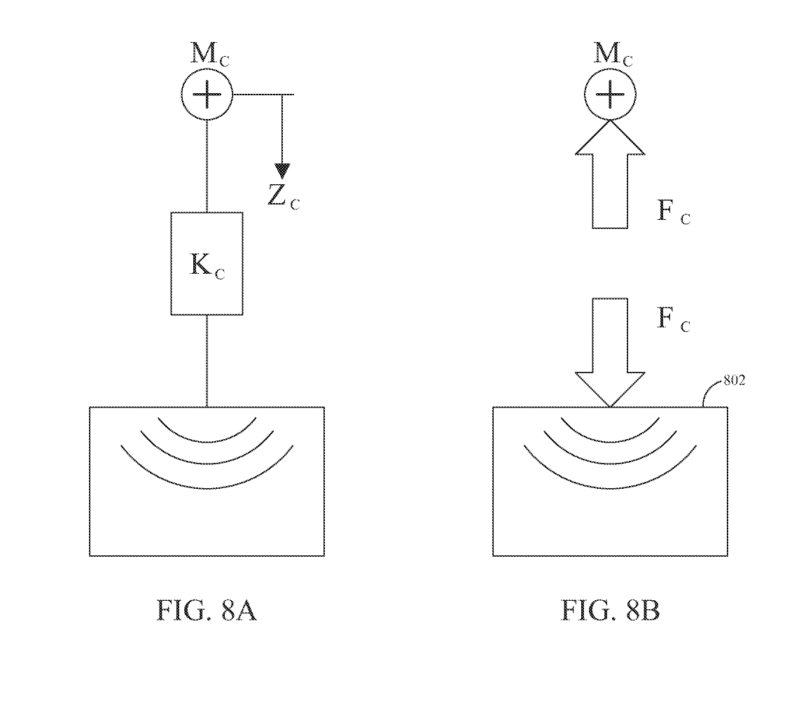

FIGS. 8A-B illustrate a low-frequency model associated with the source assembly and how the resultant force of equation (2) is imparted into the ground. In this respect, FIG. 8A shows the source assembly's center of mass, which moves up and down, and FIG. 8B shows the reaction force F_{c} that is being transmitted into the earth's surface through a coupling mechanism characterized by coupling constant Kc. Coupling constant Kc may describe the spring rate of the tires or tracks if the coupling mechanism is the tires or tracks. However, if the coupling mechanism is the baseplate, coupling constant Kc describes this direct contact via the baseplate.

FIG. 8B shows the vertical contact force F_{c} being directed toward the earth's surface 802 and an equal and opposite reaction force acting upon vehicle mass M_{c}. In one embodiment, the target is to estimate F_{c} and use it as a source seismic signature, much as has been done previously using the weighted sum estimate for ground force when the vibrator is sweeping in the traditional way.

The above discussion has been simplified to explain the basic concepts associated with generating low-frequency energy while the baseplate is not in contact with the ground. In practice, the source assembly may operate on an incline and/or travel over hills, valleys and bumps. Thus, a more sophisticated scheme to better estimate the vertical contact force would to be to use 3-component accelerometers that are responsive to gravity, and then perform a vector rotation of the 3-components based upon the direction of the gravity field to compute the vertical acceleration component. Another scheme might be to use single-component accelerometers, but also have a few inclinometers mounted on the vehicle to determine its longitudinal and transverse inclines, and use those readings to correct the accelerometer measurements. To facilitate matters, multi-channel source signal acquisition system 614 may contain a computing device for computing and estimating force F_{c}. Force F_{c} could be stored along with the individual source sensor measurements, and the individual measurements could be used as a backup should it be determined later that a sensor had failed and the estimate of F_{c} needs to be corrected.

Force F_{c} discussed above is helpful to improve seismic surveys that use compression waves or p-waves. However, if seismic surveys that use s-waves are considered, then, according to an embodiment, the traction forces that create s-waves due to the tires need to be estimated. A similar scheme could be devised to incorporate the horizontal accelerations of the subassemblies to estimate the horizontal traction forces imparted by the tires/tracks as the vehicle moves. Thus, in one embodiment, it is possible to estimate vertical force F_{c} and/or a horizontal force that produces the low-frequency energy imparted by the source assembly while the baseplate is not in contact with the ground.

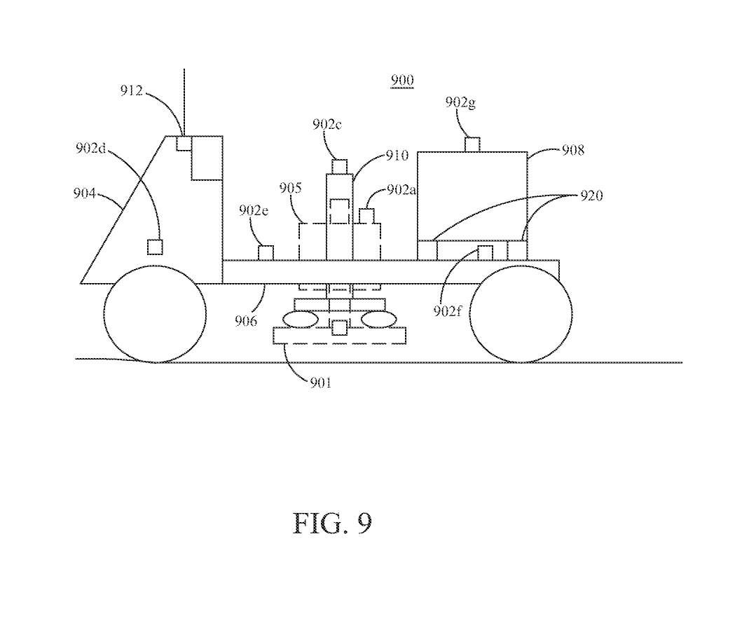

The spectral content of force F_{c} may be controlled/altered up to a point, as now discussed. For example, according to an embodiment illustrated in FIG. 9, power pack 908 of source assembly 900 may be vibration-isolated from the vehicle frame 906 by isolator devices 920. Also, it may be desirable to place a separate accelerometer 902g on the isolated power pack 908 to determine its motion. As noted above, the type of selected sensor may determine not only vertical motion, but also horizontal motion of the structure to which the sensor is attached. In this embodiment, power pack 908 in combination with isolator devices 920 acts like a spring-mass system that introduces some effects on the spectral content of F_{c}. Thus, by controlling the characteristics of the power pack (or any other auxiliary equipment) and/or isolators, the spectral content of F_{c} can be altered.

For example, the F_{c}'s spectral output would be enhanced at the resonant frequency of the spring-mass system and be attenuated at other frequencies when compared to the case where power pack 908 is rigidly attached to vehicle's frame 906. Thus, it is possible that isolator devices 920 are selected to enhance certain frequencies that are deficient to spectrally redistribute Fc. For example, the spring rate of isolator device 920 could be changed. If an air-cylinder was used as the isolator, the air pressure could be increased to increase the spring rate.

To provide an example for a better understanding of the concept of spectrally altering the output of force F_{c}, assume that as the source assembly moves (e.g., Nomad 65 vibrator manufactured by Sercel), the source assembly exhibits peak vertical accelerations of 0.01 G (0.98 m/s²), which results in a contact force of F_{c}=0.98 m/s²×31,500 kg or 154 kN. At a frequency of 1 Hz, an acceleration of 0.01 G corresponds to a vertical dynamic displacement of only 2.5 cm. A Nomad 65 source assembly is only capable of producing about 8 kN of peak ground force at that frequency while sweeping, due to stroke constraints. Thus, one skilled in the art would appreciate that the amount of force F_{c} generated during the move-up stage is much larger than the force generated while the baseplate is in contact with the ground, which is very advantageous for the low-frequency energy portion of the seismic survey.

In one embodiment, the vertical compressive contact force F_{c} can be calculated differently than as discussed above. For example, suppose that the tires of the source assembly are the mechanism by which the vehicle motion force is transmitted to the earth when the baseplate is up. According to this embodiment, the location of the accelerometers on the vehicle may be chosen to be on the frame, e.g., over the axles of the vehicle. Using a truck scale, it is possible to weigh the static contact force applied by each tire to the ground and use that for the accelerometer signal weighting parameters. This can be done per wheel instead of per axle. For this case the baseplate is up. This will be considered to be mode 1 acceleration weight values.

Next, it is possible to make the same measurement, but this time with the baseplate is in contact with the ground. Then, the truck scale is used again to measure the contact force under each tire and also under the baseplate. These values are used to figure out the accelerometer weighting distribution for mode 2 operation, i.e., the situation in which the baseplate is in contact with the ground.

Therefore, when the baseplate is up and the vehicle is moving, the controller is programmed to use signals from the accelerometers located on the frame over the axles or wheels, which is mode 1. When the baseplate is in contact with the ground, the controller is programmed to use the frame accelerometers in combination with the accelerometers on the actuator assembly until the baseplate comes off the ground, which can be detected by the lift system pressure change, which is mode 2. Thus, the controller can be programmed to determine in which mode the source assembly is, and then to use the appropriate accelerometers information to calculate the vertical compressive contact force F_{c}.

Having defined these modes, according to another embodiment, the controller may also be programmed to incorporate a transitional weighting, which slowly switches from mode 1 to mode 2 or vice versa. In this case, the controller handles time-variant weighting, which is applied to each acceleration signal as the modes change.

A variation of this embodiment is to augment the accelerometer measurements or use instead some direct force measurements. For example, strain gauges located on the wheel axle may be used to estimate the vertical force being applied by the tires to the earth.

In still another variation, it is possible to use the lift cylinder pressures, with knowledge of the lift cylinder piston area, to estimate the change in force being applied to the earth as the baseplate is being raised and lowered. Those skilled in the art would know, based on this specification, to implement other variations of these embodiments for measuring the force exerted by the source assembly on the ground.

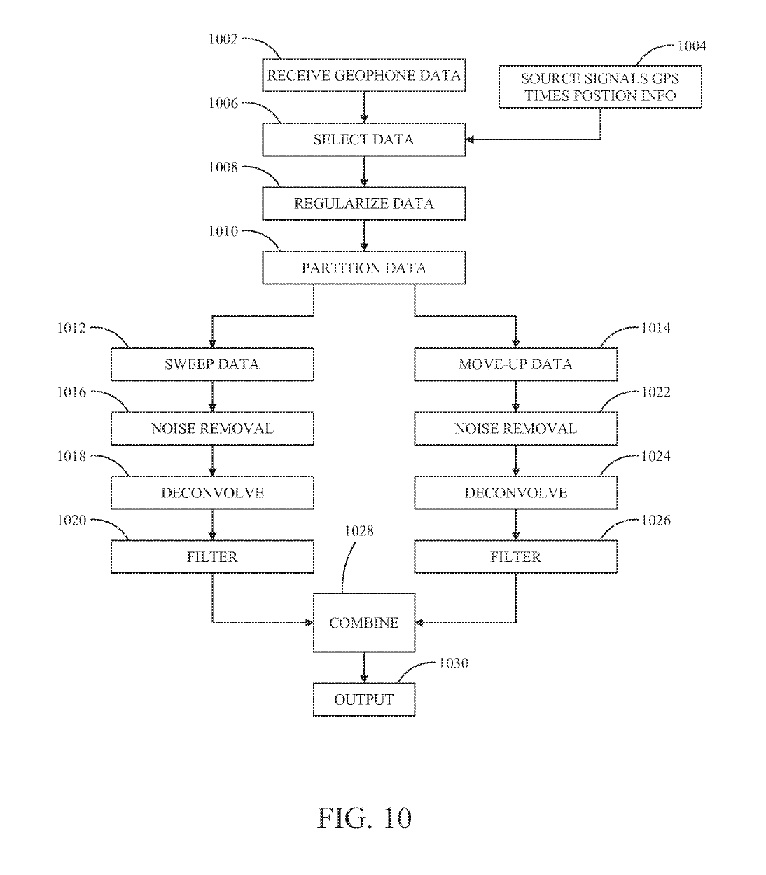

When the seismic survey is complete, the recorded seismic data includes data generated by the force exerted by the baseplate directly on the ground and also data generated by a force exerted by the source assembly while the baseplate is not in direct contact with the ground. The former is called herein sweep data and the latter is called herein move-up data because this data is generated due to the source assembly's move-up. The move-up data needs to be processed together with the conventional sweep data, and an algorithm for achieving this is now discussed with reference to FIG. 10.

In step 1002, seismic data (e.g., geophone data) that includes both move-up data and sweep data is received by a processing device, e.g., a processor. GPS data and source signals are received in step 1004. The source signals may be the measured signals necessary to characterize the output of the truck for when it is sweeping and when it is not sweeping and/or moving. Thus, signals like the baseplate and reaction mass accelerations and/or the ground force signal (a weighted sum estimate of the ground force) are useful for measuring the sweep output. Any one or combination of the aforementioned source signals as well as vehicle motion signals (acceleration, velocity or displacement), GPS signals that indicate location and elevation and time stamp, and other signals like strain gage signals to measure force applied through the tires, or pressure signals from the lift system, or lift position information may constitute the source signals. In this step, force F_{c} may be estimated if not already done during the acquisition stage. In step 1006, the data sets that correspond to the shot point of interest are selected from the mother records received in step 1002. This selection may be performed using the GPS coordinates of the source in combination with the time stamps for both the geophone data records and the source signal recordings. If for some reason the sample rates of the receiver signal and source signal are not the same, or there is some time skew correction required, re-sampling and de-skewing of the data can be performed in step 1008. Thus, as a result of this step, the source and receiver data sets are properly aligned in time.

In step 1010, the output of step 1008 is divided into two parts. The first part is the portion of the recording that corresponds to the sweep data 1012 acquired during the sweep and listen time. A second part, due to vehicular activity, is the move-up data 1014 and enters a different leg of the process flow as illustrated in FIG. 10. For example, the output of step 1008 can be divided based upon time stamp and/or sweep information. More specifically, one can look at the time stamp for the start of the sweep and the duration of the sweep and, optionally, this may include the listen time after the sweep (e.g., 2-8 s), strip out the actuator sweep signals (baseplate acceleration, mass acceleration and/or the weighted sum estimate of the ground force signal) and the resulting data set is used to form the source signature during a sweep. The second set of signals includes the signals from the actuator and the vehicle motion sensors (and any other information from pressure sensors, etc.) for the time that the vehicle is not sweeping. This data set includes recorded measurements when the baseplate is raised and lowered as well as when the vehicle is in motion.

The sweep data 1012 goes through the normal flow, which may include noise removal in step 1016 (e.g., de-spiking, muting, power line interference removal, cross-talk removal, etc.), followed by source signature deconvolution in step 1018 using the ground force estimate or cross-correlation with the sweep reference signal. Additional filtering to remove unwanted artifacts may be performed in step 1020.

The move-up data 1014 undergoes a similar process, which includes a noise removal step 1022. If the sweep data 1012 has been deconvolved in step 1018 and gone through the left leg of the algorithm, an estimate of the sweep contribution to the record can be removed as part of the noise removal process in step 1022. Then, in step 1024, the denoised move-up data is deconvolved similar to step 1018. Rather than using the sweep reference signal for deconvolution in step 1018, in this case the F_{c} estimate may be used as the source signature. The result after deconvolution in step 1024 is filtered in step 1026. The applied filter may be a band pass filter with a pass band extending approximately from 0.5 to 5 Hz, for example.

In step 1028, the two records are combined to form a conventional shot gather that has an enhanced low-frequency portion due to the contribution from the vehicle motion. Combining the records may require steps like normal moveout (NMO) correction or a variable weighting that is time-variant. After the two shot gathers are combined in step 1028, the results are output and stored in step 1030 and made available to subsequent processing steps.

Other processing schemes might be employed to make use of the vehicle motion energy. For example, the receiver energy spanning interval 516 in FIG. 5, corresponding to the midpoint from the previous move-up interval 506 through the sweep interval and onto the midpoint of the next move-up interval 514, may be selected for processing. In this case, the source signal data and the geophone data recorded over interval 516 might be processed together by deconvolution using the corresponding source signal data corresponding to interval 516. Thus, rather than partitioning the data as indicated in step 1010 in FIG. 10, the data is treated in the aggregate rather than separately.

If more than one source assembly is active at the same time, which is typically the case in high-productivity applications, other processing steps to separate out their contributions may be required. If the other source assemblies are some distance apart, the interference is weak, resulting in less cross-talk, and so the steps necessary to remove the noise artifacts should be straightforward. At any particular instant of time, the source assemblies generally are spaced apart and/or travel different paths and, thus, their vehicle motion and resultant F_{c} contributions should be uncorrelated with one another. This fact further aids the ability to distinguish and separate out their individual contributions.

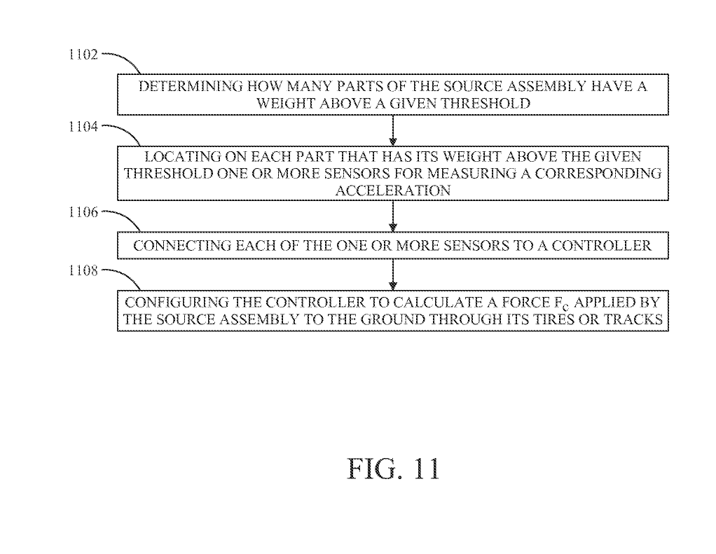

According to an exemplary embodiment, illustrated in FIG. 11, there is a method for capturing a low-frequency energy generated by a source assembly. The method includes a step 1102 of determining how many parts of the source assembly have a weight above a given threshold; a step 1104 of locating on each part that has its weight above the given threshold one or more sensors for measuring a corresponding acceleration; a step 1106 of connecting each of the one or more sensors to a controller; and a step 1108 of configuring the controller to calculate a force F_{c} applied by the source assembly to the ground through its tires or tracks.

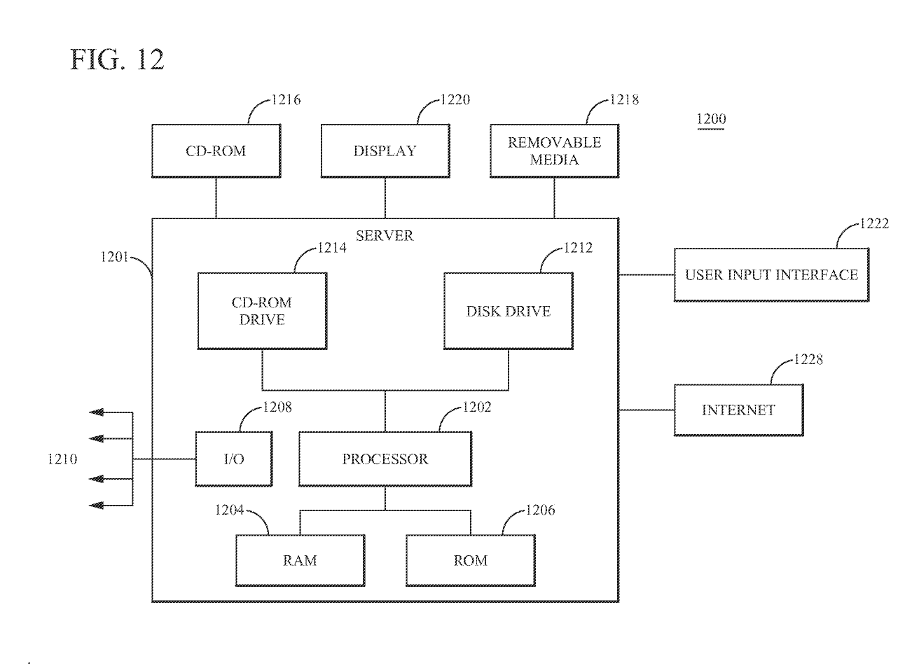

The above-discussed procedures and methods may be implemented in a computing device as illustrated in FIG. 12. Hardware, firmware, software or a combination thereof may be used to perform the various steps and operations described herein. Computing device 1200 of FIG. 12 is an exemplary computing structure that may be used in connection with such a system.

Exemplary computing device 1200 suitable for performing the activities described in the exemplary embodiments may include a server 1201. Such a server 1201 may include a central processor (CPU) 1202 coupled to a random access memory (RAM) 1204 and to a read-only memory (ROM) 1206. ROM 1206 may also be other types of storage media to store programs, such as programmable ROM (PROM), erasable PROM (EPROM), etc. Processor 1202 may communicate with other internal and external components through input/output (I/O) circuitry 1208 and bussing 1210 to provide control signals and the like. Processor 1202 carries out a variety of functions as are known in the art, as dictated by software and/or firmware instructions.

Server 1201 may also include one or more data storage devices, including hard drives 1212, CD-ROM drives 1214 and other hardware capable of reading and/or storing information, such as DVD, etc. In one embodiment, software for carrying out the above-discussed steps may be stored and distributed on a CD-ROM or DVD 1216, a USB storage device 1218 or other form of media capable of portably storing information. These storage media may be inserted into, and read by, devices such as CD-ROM drive 1214, disk drive 1212, etc. Server 1201 may be coupled to a display 1220, which may be any type of known display or presentation screen, such as LCD, plasma display, cathode ray tube (CRT), etc. A user input interface 1222 is provided, including one or more user interface mechanisms such as a mouse, keyboard, microphone, touchpad, touch screen, voice-recognition system, etc.

Server 1201 may be coupled to other devices, such as sources, detectors, etc. The server may be part of a larger network configuration as in a global area network (GAN) such as the Internet 1228, which allows ultimate connection to various landline and/or mobile computing devices.

The disclosed exemplary embodiments provide a system and a method for enhancing low-frequency energies imparted into the ground. It should be understood that this description is not intended to limit the invention. On the contrary, the exemplary embodiments are intended to cover alternatives, modifications and equivalents, which are included in the spirit and scope of the invention as defined by the appended claims. Further, in the detailed description of the exemplary embodiments, numerous specific details are set forth in order to provide a comprehensive understanding of the claimed invention. However, one skilled in the art would understand that various embodiments may be practiced without such specific details.

Although the features and elements of the present exemplary embodiments are described in the embodiments in particular combinations, each feature or element can be used alone without the other features and elements of the embodiments or in various combinations with or without other features and elements disclosed herein.

This written description uses examples of the subject matter disclosed to enable any person skilled in the art to practice the same, including making and using any devices or systems and performing any incorporated methods. The patentable scope of the subject matter is defined by the claims, and may include other examples that occur to those skilled in the art. Such other examples are intended to be within the scope of the claims.

What is claimed is:

1. A source assembly for enhancing low-frequency seismic signals, the source assembly comprising:
a vehicle configured to move to a desired location above ground;
a lift and hydraulic actuator system attached to the vehicle and configured to generate seismic waves into the ground;
auxiliary equipment attached to the vehicle; and
one or more sensors located on the vehicle or the auxiliary equipment for measuring a vertical acceleration or a representation of the vertical acceleration of the source assembly.

2. The source assembly of claim 1, wherein the one or more sensors are distributed on a frame of the vehicle and the auxiliary equipment.

3. The source assembly of claim 1, wherein the one or more sensors are accelerometers.

4. The source assembly of claim 1, further comprising:
a controller located on the vehicle and communicating with the one or more sensors, wherein the controller receives sensor information as the vehicle moves from one location to another and/or while a baseplate is being lowered or raised.

5. The source assembly of claim 4, wherein the controller is connected to a memory that stores a specification of the source assembly, and the controller is configured to calculate a vertical force F_{c} exerted by the source assembly on the ground while the baseplate is away from the ground.

6. The source assembly of claim 5, wherein the controller calculates the vertical force F_{c} based on a mass distribution of the source assembly, which is stored in the memory, and the accelerations measured by each of the one or more sensors.

7. The source assembly of claim 1, wherein a number of the one or more sensors and their locations on the source assembly, except on the lift and hydraulic actuator system, are selected before starting a seismic survey so that a low-frequency energy imparted into the ground by the source assembly is enhanced during a move-up stage.

8. The source assembly of claim 1, wherein the one or more sensors may be redistributed along the source assembly for improving the measured force F_{c}.

9. The source assembly of claim 1, wherein the one or more sensors are located on a frame of the vehicle, on the lift and hydraulic actuator system at a few locations, and on the auxiliary equipment that has a weight over a given threshold.

10. The source assembly of claim 1, wherein the lift and hydraulic actuator system has a baseplate and associated acceleration sensor.

11. The source assembly of claim 1, further comprising:
isolator devices located between a frame of the vehicle and the auxiliary equipment for altering a frequency generated by a movement of the source assembly when a baseplate is not in contact with the ground.

12. The source assembly of claim 11, wherein the isolator devices are modified to adjust a spectral composition of a vertical force applied to the ground.

13. A method for capturing a low-frequency energy generated by a source assembly, the method comprising:
determining how many parts of the source assembly have a weight above a given threshold;
locating on each part that has its weight above the given threshold one or more sensors for measuring a corresponding acceleration;
connecting each of the one or more sensors to a controller; and
configuring the controller to calculate a force F_{c} applied by the source assembly to the ground through its tires or tracks.

14. The method of claim 13, wherein the force F_{c} is calculated based on outputs from the one or more sensors and individual masses of the parts.

15. The method of claim 13, wherein the parts include a vehicle and auxiliary equipment.

16. The method of claim 15, wherein the parts do not include a lift and hydraulic actuation mechanism that includes a baseplate.

17. The method of claim 13, wherein the force F_{c} is applied when a baseplate is not in contact with the ground.

18. The method of claim 13, wherein the force F_{c} is applied while the source assembly travels from one shot point to another.

19. A method for enhancing a low-frequency energy generated by a source assembly, the method comprising:
moving the source assembly from one shot point to another shot point;
lowering or raising a baseplate of a lift and hydraulic actuator system at a given shot point;
recording vertical displacements of the source assembly with one or more sensors while the source assembly moves from the one shot point to another shot point or while the baseplate is lowered or raised;
processing the vertical displacements in a controller to determine a vertical force F_{c} applied by the source assembly to the ground; and
using the vertical force F_{c} to process seismic data recorded with seismic sensors.

20. The method of claim 19, wherein the seismic sensors record sweep data while the baseplate is in contact with the ground and move-up data while the baseplate is away from the ground, wherein the sweep data is traditional seismic data and the move-up data is data recorded by the seismic sensors due to vertical movement of a carrier of the lift and hydraulic actuator system.
